(19) United States
(12) Patent Application Publication
(10) Pub. No.: US 2012/0250299 A1
(43) Pub. Date: Oct. 4, 2012

(54) PARTIALLY RECESSED LUMINAIRE

(76) Inventors: Thomas D. Dreeben, Swampscott, MA (US); James A. Gotay, Lowell, MA (US)

(21) Appl. No.: 13/076,141

(22) Filed: Mar. 30, 2011

(51) Int. Cl. F21L 13/00; F21V 21/00; F21V 29/00

(52) U.S. Cl. 362/190

(57) ABSTRACT

A rectangular luminaire includes a rectangular fixture defining at least one cavity having a plurality of light engines. A heat flange is disposed about a distal end region of the rectangular fixture and includes a hollow, generally pyramidal frustum shape with a generally rectangular cross-section. A distal-most end of the heat flange is configured to be disposed a distance D from a support surface when the rectangular fixture is received in a recess of the support surface, the distance D being greater than or equal to 0.4 times the fixture half-width W. Thermal energy is conductively transferred from the light engine, through the rectangular fixture, to the heat flange where the thermal energy is convectively transferred from the heat flange to surrounding air to create air currents flowing along the support surface thereby reducing the junction temperature.

### CROSS-REFERENCE TO RELATED APPLICATIONS

This application is related to copending application Attorney Docket No. 2010P25288US, U.S. patent application Ser. No. ______, PARTIALLY RECESSED LUMINAIRE, filed simultaneously herewith, the entire disclosure of which is incorporated herein by reference.

### TECHNICAL FIELD

The present disclosure relates to luminaires, and more particularly pertains to luminaires and methods for reducing the junction temperature of a light engine.

### BACKGROUND

Luminaires, such as down lights or the like, may include a can and a light engine disposed within a cavity defined by the can. The light engine includes a light source configured to generate light. One such type of light source includes light emitting diodes, LEDs. While LEDs may generate less thermal energy compared to traditional bulbs (e.g., incandescent light bulbs), LEDs nevertheless generate thermal energy which should be managed in order to control the junction temperature. A higher junction temperature generally correlates to lower light output, lower luminaire efficiency, and/or reduced life expectancy. Unfortunately, managing thermal energy is particularly challenging when designing ceiling fixtures because temperature gradients in a room send the hottest air closest to the ceiling. Moreover, thermal insulation installed in the ceiling, and particularly proximate to the ceiling fixture, may reduce and/or suppresses natural convection. For example, the thermal insulation may have a thermal conductivity of approximately 0.04 W/(m-K), and as a result, the thermal insulation may generally only permit the removal of thermal energy upward from the ceiling fixture by thermal conduction which occurs at a far slower rate than thermal convection above the ceiling.

Another challenge facing the design of ceiling fixtures involves a plurality of ceiling fixtures installed throughout a room. In particular, the ceiling fixtures which are surrounded by other ceiling fixtures (e.g., ceiling fixtures in the middle of the room) are most vulnerable to overheating as they are farthest from the walls (which may help to act as a heat sink). Moreover, nearby ceiling fixtures generate thermal energy which reduces and/or minimizes any lateral temperature gradient across the ceiling. As a result, thermal energy is generally limited to upward and downward. Because hot air rises, most of the thermal energy must travel through the insulated ceiling.

### BRIEF DESCRIPTION OF THE DRAWINGS

Features and advantage of the claimed subject matter will be apparent from the following description of embodiments consistent therewith, which description should be considered in conjunction with the accompanying drawings, wherein:

FIG. 1 is a block diagram of one exemplary embodiment of a system consistent with the present disclosure;

FIG. 2 is a cross-sectional view of one embodiment of a luminaire consistent with the present disclosure;

FIG. 3 is a cross-sectional view of the luminaire of FIG. 2 received within a recess of a support surface consistent with the present disclosure;

FIG. 4 is a cross-sectional view of another embodiment of a luminaire consistent with the present disclosure;

FIG. 5 is a cross-sectional view of yet another embodiment of a luminaire consistent with the present disclosure;

FIG. 6 is a cross-sectional view of a further embodiment of a luminaire consistent with the present disclosure;

FIG. 7 is a cross-sectional view of another embodiment of a retrofit luminaire consistent with the present disclosure;

FIG. 8 is a cross-sectional view of another embodiment of a luminaire consistent with the present disclosure;

FIGS. 9A and 9B are cross-sectional views illustrating the placement of thermocouples T1 and T2;

FIG. 10 depicts a comparison of the temperatures of the thermocouples T1 in a partially-recessed luminaire consistent with the present disclosure and a flush-mounted luminaire;

FIG. 11 depicts a comparison of the temperatures of the thermocouples T2 in a partially-recessed luminaire consistent with the present disclosure and a flush-mounted luminaire;

FIG. 12 depicts the maximum temperature and heat rejection as function of the ratio of the heat flange depth to the cavity is varied;

FIG. 13 depicts the maximum horizontal air velocity as the ratio of depth of the heat flange to the cavity is varied;

FIG. 14 depicts the maximum temperature and heat rejection as a function of the ratio of the flange half-width r to normalized diameter of luminaire;

FIG. 15 depicts the maximum horizontal air velocity along the ceiling as a function of the normalized luminaire diameter;

FIG. 16 is a block flow diagram of one exemplary method consistent with the present disclosure;

FIG. 17 is a perspective view of one embodiment of a rectangular luminaire consistent with the present disclosure;

FIG. 18 is a cross-sectional view of the rectangular luminaire of FIG. 17 taken along lines A-A;

FIG. 19 is a perspective view of another embodiment of a rectangular luminaire consistent with the present disclosure;

FIG. 20 is a cross-sectional view of the rectangular luminaire of FIG. 19 taken along lines B-B; and

FIG. 21 is a cross-sectional view of yet another embodiment of a rectangular luminaire consistent with the present disclosure.

### DETAILED DESCRIPTION

By way of an overview, one aspect consistent with the present disclosure may feature a luminaire including a fixture, a light engine coupled to the fixture, and a heat flange configured to extend outwardly beyond the mounting surface of the luminaire. The heat flange reduces the junction temperature of the light engine by increasing the amount of convection in the surrounding air, thereby increasing the volumetric air flow across the fixture as well as the air velocity. As used herein, the term “junction temperature” is intended to refer to the maximum temperature of the light engine when operating at steady state power. In particular, thermal energy is conductively transferred from the light engine, through the fixture, to the heat flange where the thermal energy is convectively transferred from the heat flange to surrounding air to create air currents flowing along the support surface. The increased volumetric air flow and velocity transfers a greater amount of thermal energy from the fixture into the surrounding air, thereby reducing the junction temperature of the light engine. In addition, the shape of the heat flange increases the air velocity across the mounting surface of the luminaire, thereby exposing the heated air to a larger area of the mounting surface, and reducing the temperature difference needed to transfer the thermal energy from the air to the mounting surface. Reducing the junction temperature of the light engine may increase the life expectancy of the light engine and/or may allow the light engine to be operated at a higher luminance while also maintaining an acceptable service life.

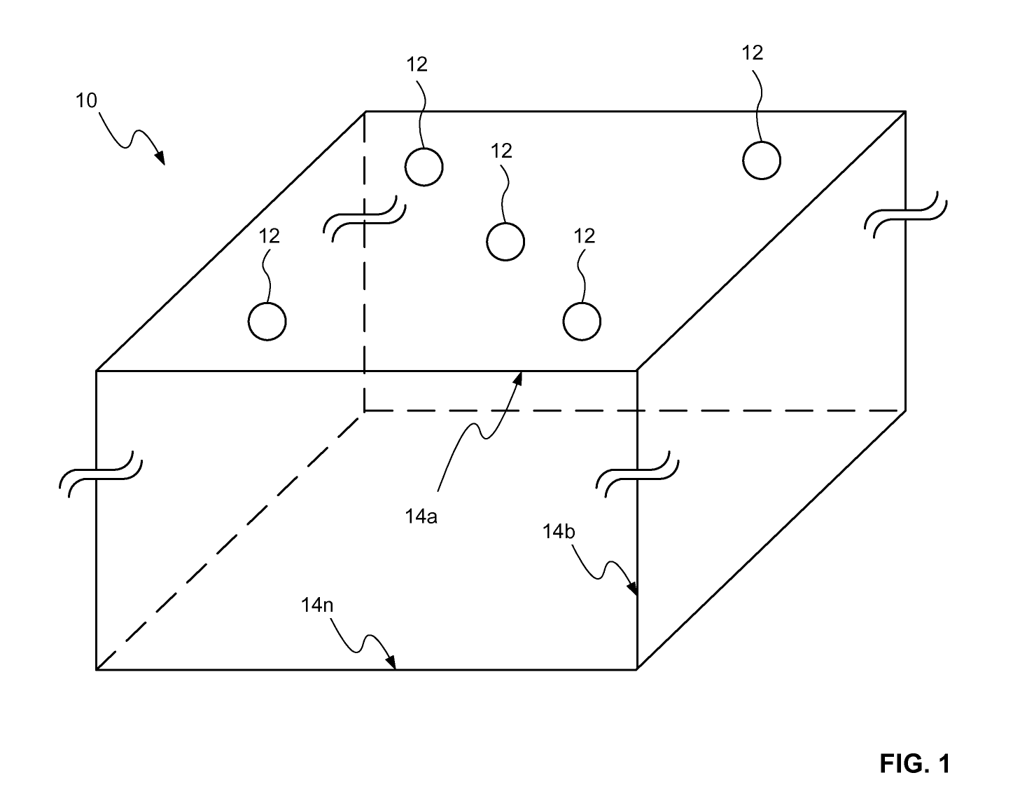

Turning now to FIG. 1, one embodiment illustrating a lighting system 10 consistent with the present disclosure is generally illustrated. The lighting system 10 includes at least one partially-recessed luminaire 12 coupled, mounted, fixed, or otherwise secured to at least one mounting substrate 14a-n. For the sake of brevity, the partially-recessed luminaire 12 (also referred to simply as “luminaire”) will be described as a being coupled to a ceiling 14a; however, it will be appreciated that the luminaire 12 may also be coupled to any mounting substrate 14a-n such as, but not limited to, a wall 14b, floor 14n, roof, or the like.

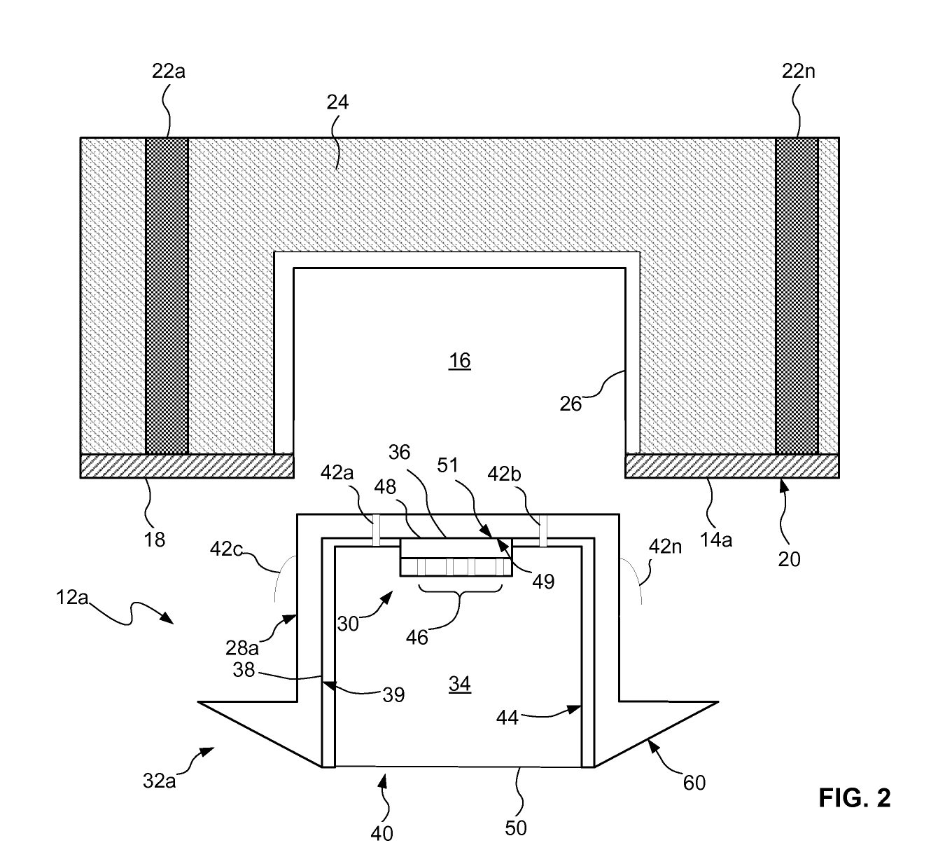

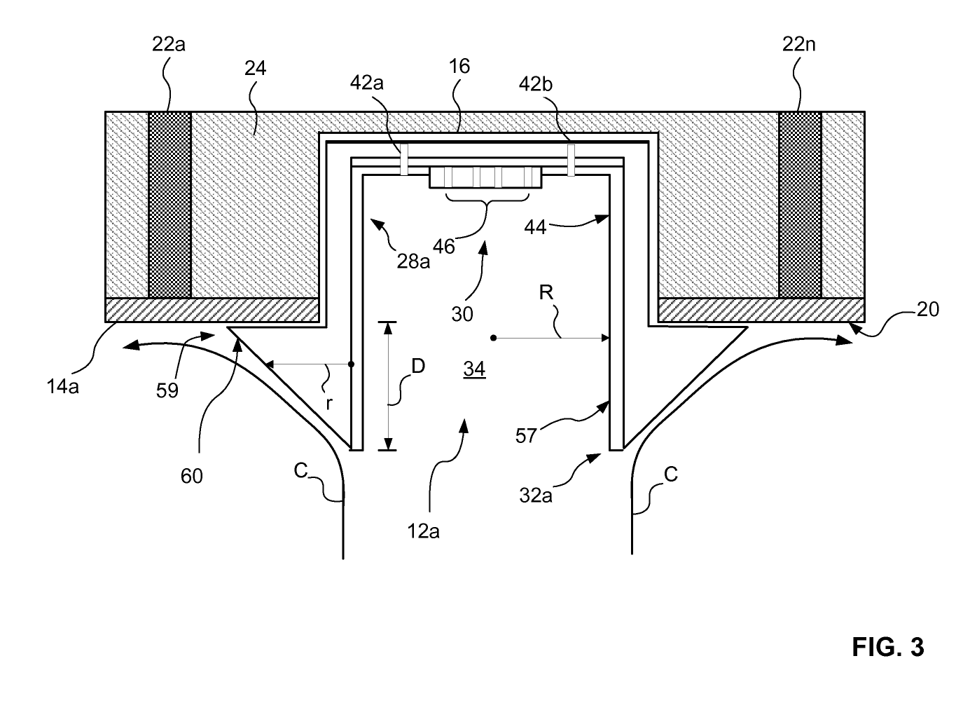

Referring now to FIGS. 2 and 3, a cross-sectional view of one embodiment of a luminaire 12a for use with a ceiling 14a is generally illustrated. The luminaire 12a may be configured to be at least partially received in a recess 16 formed within the ceiling 14a, for example, as generally illustrated in FIG. 3. The ceiling 14a may include an exterior layer 18 (for example, but not limited to, sheet rock, wood, a dropped ceiling, or the like) having a bottom surface 20, at least one stud or support 22a-n, and optionally insulation 24 (such as, but not limited to, thermal and/or sound insulation). As used herein, the exterior layer 18 and bottom surface thereof are intended to refer to the layer and surface of the ceiling 14a which are exposed to the area illuminated by the luminaire 12. Optionally, the recess 16 may include an electrical box 26 depending on the building codes. For example, the electrical box 26 may include any electrical box compatible with UL® or the like. One or more electrical wires (not shown for clarity) may be provided to supply AC and/or DC current to the luminaire 12. The recess 16 and/or electrical box 26 may have any shape such as, but not limited to, a generally square, generally rectangular, or generally circular shape.

The luminaire 12a includes a fixture 28a, a light engine 30 configured to be coupled to the fixture 28a, and a heat flange 32a configured to extend outwardly beyond the bottom surface 20 of the ceiling 14a when the luminaire is fully received in the recess as shown in FIG. 3. The fixture 28a may define a cavity 34 having a base 36, at least one sidewall 38, and an open end 40. The fixture 28a may be made from a material with a high thermal conductivity such as, but not limited to, a material having a thermal conductivity of 100 W/(m*K) or greater, for example, 200 W/(m*K) or greater. According to one embodiment, the fixture 28a may include a metal or metal alloys (such as, but not limited to, aluminum, copper, silver, gold, or the like), plastics (e.g., but not limited to, doped plastics), as well as composites. The size, shape and/or configuration (e.g., surface area) of the fixture 28a may depend upon a number of variables including, but not limited to, the maximum power rating of the light engine 30, the size/shape of the recess 16 and/or electrical box 26, and the like.

The fixture 28a may include one or more mounting devices 42a-n for securing the luminaire 12a to the recess 16 and/or electrical box 26. The mounting devices 42a-n may include one or more openings or passages 42a, b extending through the fixture 28a for receiving a fastener (such as, but not limited to, a screw, bolt, or the like, not shown for clarity) which may engage a corresponding feature of the recess 16 and/or electrical box 26 (also not shown for clarity). Alternatively (or in addition), the mounting device 42a-n may include one or more biasing devices (such as, but not limited to, biased tabs, springs, or the like 42c) configured to engage a portion of the sidewalls of the recess 16 and/or electrical box 26.

Optionally, the fixture 28a may include one or more surface layers 44 covering at least a portion of the internal surface of at least one of the base 36 and sidewall 38. The surface layers 44 may include an optical coating configured to reflect and/or direct light generated from the light engine 30 out the open end 40. For example, the optical coating may include a reflector and/or a lens configured to direct and/or focus light emitted from the light engine 30 out of the open end 40 of the luminaire 12a. Alternatively (or in addition), the surface layers 44 may include a thermal layer configured to increase the amount of thermal energy transferred from the light engine to the heat flange 32a. For example, the thermal layer may also have a high thermal conductivity, k, (e.g., but not limited to, a thermal conductivity, k, of 1.0 W/(m*K) or greater) to transfer thermal energy from the light engine 30 into the fixture 28a and to the heat flange 32a, thereby reducing the junction temperature of the light engine 30. The fixture 28a may also optionally include a lens and/or diffuser 50 extending across the open end 40 configured to diffuse the light emitted from the light engine 30.

The light engine 30 may include any light source including, but not limited to, gas discharge light sources (such as, but not limited to, high intensity discharge lamps, fluorescent lamps, low pressure sodium lamps, metal halide lamps, high pressure sodium lamps, high pressure mercury-vapor lamps, neon lamps, and/or xenon flash lamps) as well as one or more solid-state light sources (e.g., but not limited to, semiconductor light-emitting diodes (LEDs), organic light-emitting diodes (OLED), or polymer light-emitting diodes (PLED), hereinafter collectively referred to as “LEDs 46”). The number, color, and/or arrangement of LEDs 46 may depend upon the intended application/performance of the luminaire 12a. The LEDs 46 may be coupled and/or mounted to a substrate (e.g., but not limited to, a ballast, PCB or the like 48). The PCB 48 may comprise additional circuitry (not shown for clarity) including, but not limited to, resistors, capacitors, etc., which may be operatively coupled to the PCB 48 configured to drive or control (e.g., power) the LEDs 46. According to one embodiment, the PCB 48 may be directly coupled to the fixture 28a. For example, a first surface 49 of the PCB 48 may contact or abut against a surface 51 of the fixture 28a to conduct thermal energy away from the LEDs 46.

Optionally, the light engine 30 also includes one or more thermal interface materials (e.g., gap pads, not shown for clarity) disposed between the PCB 48 and the fixture to decrease the contact thermal resistance between the PCB 48 (and LEDs 46) and the fixture 28a. The thermal interface material may include outer surfaces which directly contact (e.g., abut against) surfaces 49, 51 of the PCB 48 and the fixture 28a, respectively. The thermal interface material may include a material having a higher thermal conductivity, k, configured to reduce the thermal resistance between the PCB 48 and the fixture 28a. For example, the thermal interface material may have a thermal conductivity, k, of 1.0 W/(m*K) or greater, 1.3 W/(m*K) or greater, 2.5 W/(m*K) or greater, 5.0 W/(m*K) or greater, 1.3-5.0 W/(m*K), 2.5-5.0 W/(m*K), or any value or range therein. The thermal interface material may include a deformable (e.g., a resiliently deformable) material configured to reduce and/or eliminate air pockets between the outer surfaces 49, 51 of the PCB 48 and the fixture 28a to reduce contact resistance. The thermal interface material may have a high conformability to reduce interface resistance

The interface material may have a thickness of from 0.010″ to 0.250″ when uncompressed. Optionally, one or more outer surfaces of the first thermal interface material may include an adhesive layer configured to secure the thermal interface material to the PCB 48 or the fixture 28a, respectively. The adhesive may be selected to facilitate thermal energy transfer (e.g., the adhesive may have a thermal conductivity k of 1 W/(m*K) or greater. Additionally (or alternatively), the PCB 48 and the fixture 28a may be coupled (e.g., secured) together using one or more fasteners such as, but not limited to, screws, rivets, bolts, clamps, or the like. The thermal interface material may also be electrically non-conductive (i.e., an electrical insulator) and may include a dielectric material.

As discussed above, the luminaire 12a also includes a heat flange 32a coupled to the fixture 28a. The heat flange 32a may be made from a material having a high thermal conductivity (such as, but not limited to, a material having a thermal conductivity of 100 W/(m*K) or greater, for example, 200 W/(m*K) or greater) configured to transfer thermal energy away from the fixture 28a, thereby reducing the junction temperature of the LEDs 46 that make up the light engine 30. According to one embodiment, the fixture 28a may include a metal or metal alloys (such as, but not limited to, aluminum, copper, silver, gold, or the like), plastics (e.g., but not limited to, doped plastics), as well as composites. The heat flange 32a may be the same as the fixture 28a or a different material than the fixture 28a.

The heat flange 32a may include a hollow, generally conical frustum shape having a generally circular cross-section which generally linearly tapers radially outwardly from the distal-most end 57 towards the fixture 28a. Stated another way, the half-width r of the conical heat flange 32a (i.e., the flange half-width r) increases from the distal-most end 57 to proximal-most end 59 of the heat flange 32a. As used herein, the term “generally conical frustum” is intended to mean that the top and base of the cone may be, but do not necessarily have to be, parallel to each other.

The distal-most end 57 of the heat flange 32a also extends downwardly a depth D beyond the bottom surface 20 of the ceiling 14a. The depth D of the heat flange 32a may be selected such that the heat flange 32a has a surface area large enough to transfer enough thermal energy from the heat flange 32 to the surrounding air by thermal convection to create an air current (as represented by arrows C) across the tapered exterior surface 60 of the heat flange 32a. The shape of the heat flange 32a also generates air currents C that flow upwardly across the heat flange 32a and radially outwardly generally parallel to the bottom surface 20 of the ceiling 14a. Because the heated air currents C flow generally along the bottom surface 20 of the ceiling 14a, a larger area of the ceiling 14a is exposed to the heated air currents C, thereby reducing the temperature differential needed to transfer thermal energy from the heated air currents C to the ceiling 14a. The net result is that more thermal energy is transferred from the light engine 30 to the air, and ultimately to the ceiling 14a, thereby reducing the junction temperature of the light engine 30.

According to one embodiment, the heat flange 32a has a depth D equal to or greater than 0.4 times the radius R of the fixture 28a (i.e., equal to or greater than 0.2 times the diameter of the fixture 28a). For example, the depth D may be equal to or greater than 0.6 times the radius R of the fixture 28a (i.e., equal to or greater than 0.3 times the diameter of the fixture 28a); equal to or greater than 0.8 times the radius R of the fixture 28a (i.e., equal to or greater than 0.4 times the diameter of the fixture 28a); and/or equal to or greater than 1.2 times the radius R of the fixture 28a (i.e., equal to or greater than 0.6 times the diameter of the fixture 28a). Alternatively, the depth D of the heat flange 32a may be selected to be greater than or equal to 0.4R and less than or equal to 2R; greater than or equal to 0.4R and less than or equal to 1.4R; greater than or equal to 0.8R and less than or equal to 1.6R; greater than or equal to 0.8R and less than or equal to 1.4R, and/or any value in between. It should be understood that all luminaires consistent with FIGS. 1-15 and the present disclosure feature heat flanges having the above described relationships between the distance D and radius R.

The conical heat flange 32a may have a maximum flange half-width r (e.g., at the proximal-most end 59 of the heat flange 32a configured to be adjacent to the ceiling 14a) equal to or greater than 0.4 times the radius R of the fixture 28a. For example, the conical heat flange 32a may have a maximum flange half-width r equal to or greater than the radius R of the fixture 28a. It should be understood that all luminaires consistent with FIGS. 1-15 and the present disclosure feature heat flanges having the above described relationships between the maximum flange half-width r and radius R.

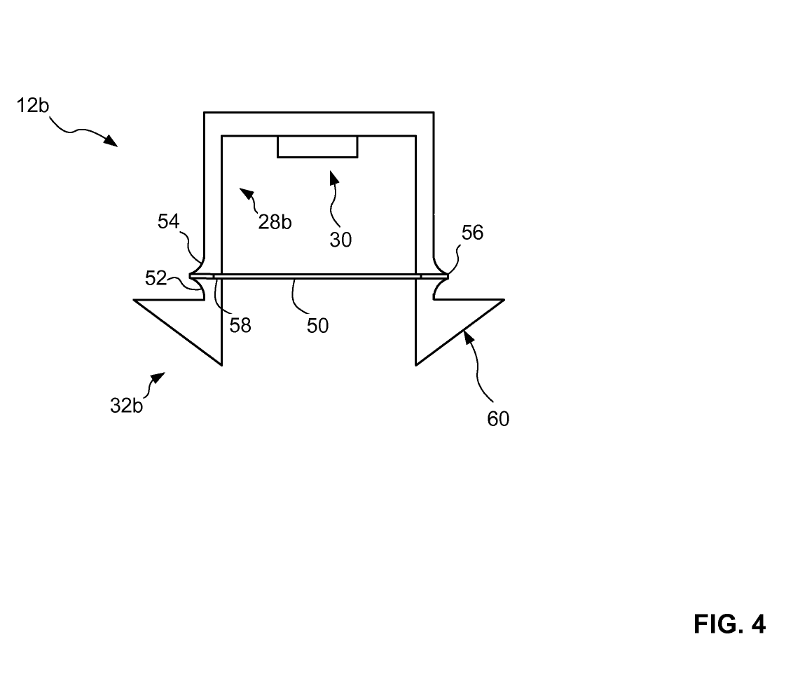

Turning now to FIG. 4, the luminaire 12b may include a fixture 28b, a light engine 30, and a heat flange 32 coupled to the fixture 28b, for example, using an adhesive, friction connection, and/or one or more fasteners (not shown for clarity). The heat flange 32b includes the same material as the fixture 28b or a different material than the fixture 28b. Optionally, the luminaire 12b may include one or more thermal interface materials 56 (e.g., gap pads) disposed between the fixture 28b and the heat flange 32b to further increase the rate of thermal energy transferred from the fixture 28b to the heat flange 32b (and ultimately away from the LEDs 46 and the PCB 48, not shown in FIG. 4 for clarity). For example, the thermal interface material 56 may include outer surfaces which at least partially contact (e.g., abut against) at least a portion of the surfaces of the heat flange 32b and/or the fixture 28b. According to one embodiment, the thermal interface material 56 may be disposed between (and optionally abut against) one or more of the flanges 52, 54 of the heat flange 32b and the fixture 28b, respectively.

The thermal interface material 56 may include a material having a reasonably high thermal conductivity, k, configured to reduce the thermal resistance between the heat flange 32b and the fixture 28b. For example, the thermal interface material 56 may have a thermal conductivity k of 1.0 W/(m*K) or greater, 1.3 W/(m*K) or greater, 2.5 W/(m*K) or greater, 5.0 W/(m*K) or greater, 1.3-5.0 W/(m*K), 2.5-5.0 W/(m*K), or any value or range therein. The thermal interface material 56 may include a deformable (e.g., a resiliently deformable) material configured to reduce and/or eliminate air pockets between the surfaces of the heat flange 32b and the fixture 28b to reduce contact resistance. The thermal interface material 56 may have a high conformability to reduce interfacial resistance.

The thermal interface material 56 may have a thickness of from 0.010″ to 0.250″ when uncompressed. Optionally, one or more outer surfaces of the thermal interface material 56 may include an adhesive layer (not shown for clarity) configured to secure the thermal interface material 56 to the fixture 28b or the heat flange 32b. Additionally (or alternatively), the fixture 28b and the heat flange 32b may be secured together using one or more fasteners (not shown for clarity) such as, but not limited to, screws, rivets, bolts, clamps, or the like. The interface material 56 may also be electrically non-conductive (i.e., an electrical insulator), and may include a dielectric material.

The heat flange 32b and the fixture 28b, when secured together, may optionally define a lens cavity 58 configured to receive at least a portion of the outer periphery of a lens/diffuser 50 such that the lens/diffuser 50 is sandwiched between the fixture 28b and the heat flange 32b. Of course, the lens/diffuser 50 may be secured between and/or to the fixture 28b and/or heat flange 32b in a variety of different manners. For example, while not an exhaustive list, the lens/diffuser 50 may be an integral component with the surface layer 44 and/or may be secured to the fixture 28b and/or heat flange 32b using a fastener, adhesive, welding (e.g., but not limited to, ultrasonic welding), or the like (not shown for clarity).

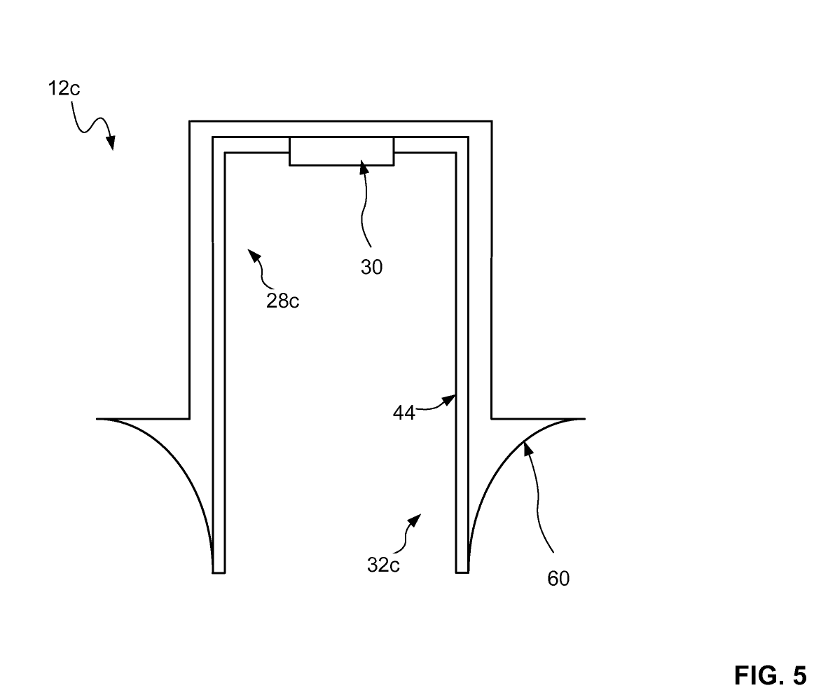

Turning now to FIG. 5, a cross-sectional view of another embodiment of a luminaire 12c is generally illustrated. The luminaire 12c includes a fixture 28c, a light engine 30, and a heat flange 32c having a hollow, generally conical frustum shape having a generally circular cross-section which curves or flares radially outwardly from the distal-most end 57 towards the fixture 28c. The curved heat flange 32c may increase the area of the surface 60 of the heat flange 32c which is exposed to the surrounding air, thereby enhancing the air currents generated. As a result, more thermal energy may be transferred from the curved heat flange 32c compared to the straight heat flange 32a (e.g., as illustrated in FIGS. 2 and 3) and the junction temperature of the light engine 30 may be further reduced.

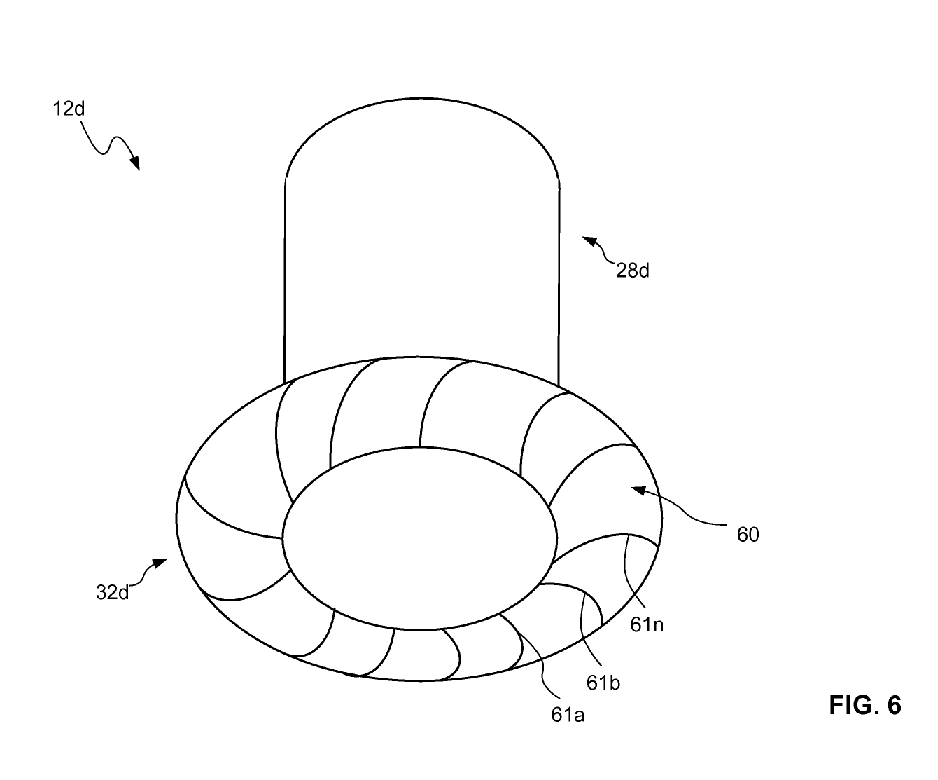

Referring now to FIG. 6, an end perspective view of yet another embodiment of a luminaire 12d is generally illustrated. The luminaire 12d includes a fixture 28d, a light engine 30 (not shown because of the view), and a heat flange 32d having one or more (e.g., a plurality) of fins 61a-n extending generally outwardly from the heat flange 32d. For example, the fins 61a-n may extend along a longitudinal axis of the luminaire 12d; however, the fins 61a-n may extend diagonally and/or perpendicular to the longitudinal axis of the luminaire 12d. The fins 61a-n may further increase the area of the surface 60 of the heat flange 32d which is exposed to the surrounding air, thereby transferring more thermal energy from the heat flange 32d compared to the straight heat flange 32a and further reducing the junction temperature of the light engine 30. The heat flange 32d may have a generally straight cross-section (e.g., as generally illustrated in FIG. 2) and/or a curved cross-section (e.g., as generally illustrated in FIG. 5). The fins 61a-n may extend generally outwardly at a constant distance from the heat flange 32d and/or may have a tapered shape. The fins 61a-n may be evenly and/or unevenly spaced along the heat flange 32d. In addition, the fins 61a-n may have a generally pin-like or generally cylindrical shape.

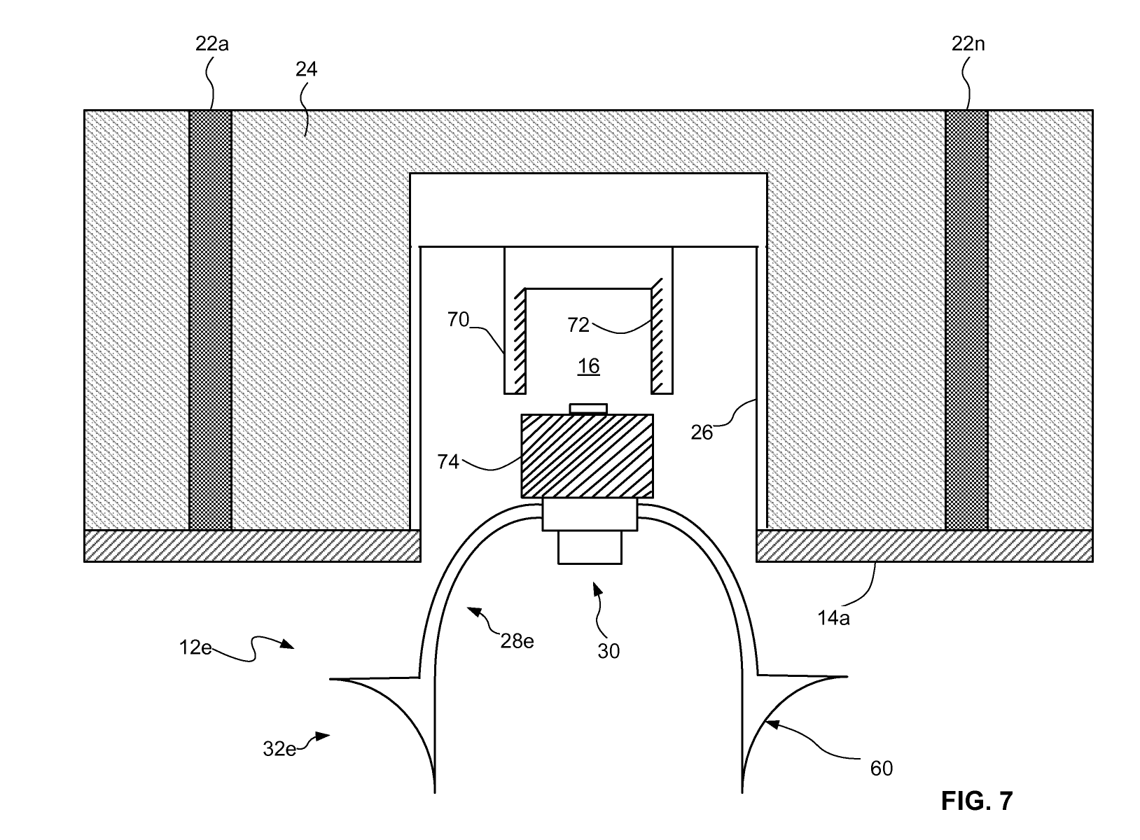

Yet another embodiment of a luminaire 12e consistent with the present disclosure is generally illustrated in FIG. 7. In particular, the luminaire 12e may be configured to be retrofitted to an existing light socket 70. The light socket 70 may include an Edison screw-type light socket having a threaded socket 72 configured to receive a corresponding threaded portion 74 of the luminaire 12e. For example, the light socket 70 may include, but is not limited to, an E12, E11, E17, E14, E26, E27, E39, or and E40. The luminaire 12e may also include a fixture 28e, a light engine 30, and a heat flange 32e. The heat flange 32e may include any heat flange consistent with the present disclosure.

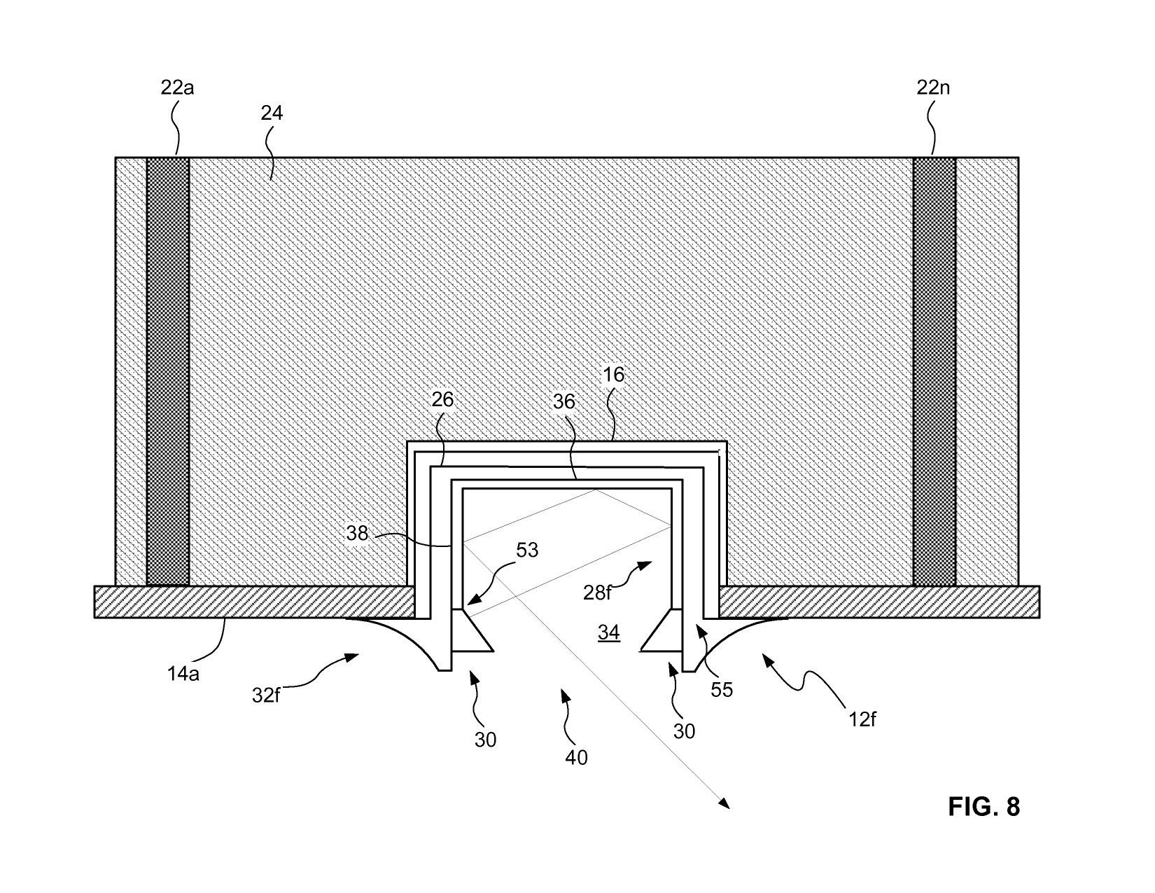

Turning now to FIG. 8, a cross-sectional view of yet a further embodiment of a luminaire 12f consistent with the present disclosure is generally illustrated. The luminaire 12f includes a fixture 28f, one or more light engines 30f, and a heat flange 32. The heat flange 32f may include any heat flange consistent with the present disclosure. Rather than having the light engine 30 disposed at the base 36 of the fixture 28f, one or more light engines 30 may be coupled to the sidewalls 38 of the fixture 28f and/or the heat flange 32f. For example, the light engines 30 may be disposed proximate to the distal end 53 of the fixture 28f and/or the proximal end 55 of the heat flange 32f. The light engine 30 may be configured to emit light directly out the open end 40 of the luminaire 12f and/or emit light into the cavity 34 where it is reflect out the open end 40. Placing the light engine 30 on the sidewalls 38 and/or the heat flange 32f may increase the amount of thermal energy which is transferred from the light engine 30 to the heat flange 32f and ultimately to the surrounding air, thereby reducing the junction temperature of the light engine 30. While not shown, the luminaire 12f may also include one or more light engines coupled to the base 36 of the fixture 12f.

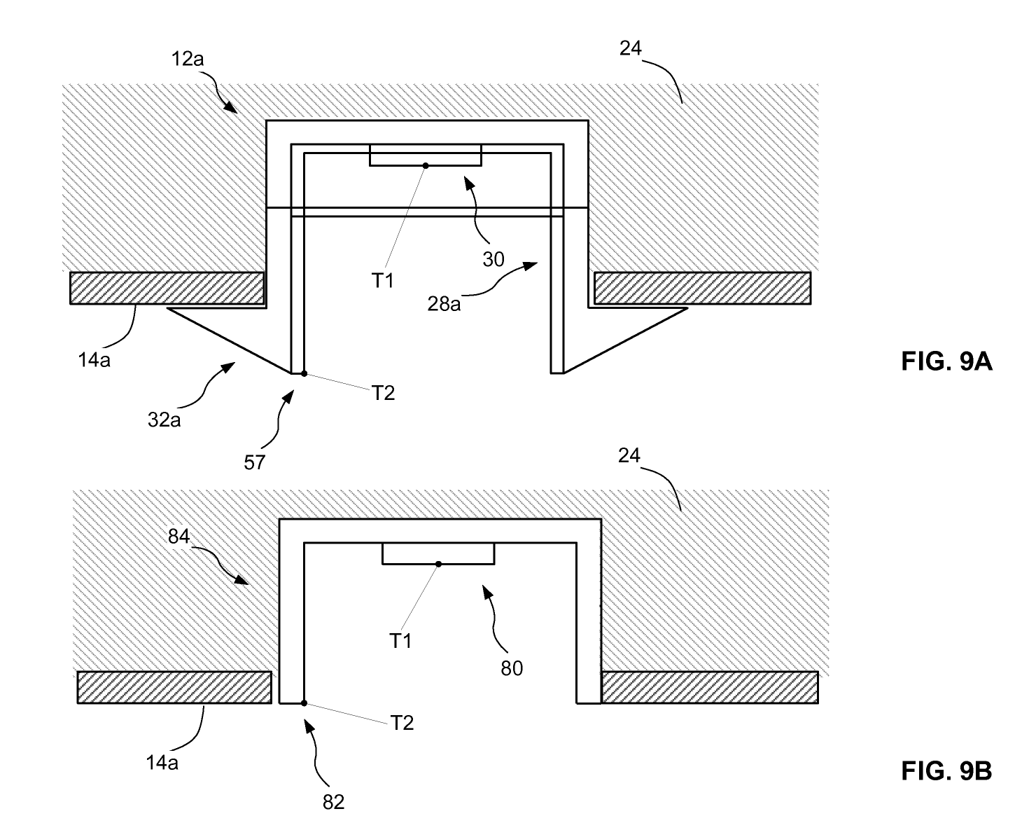

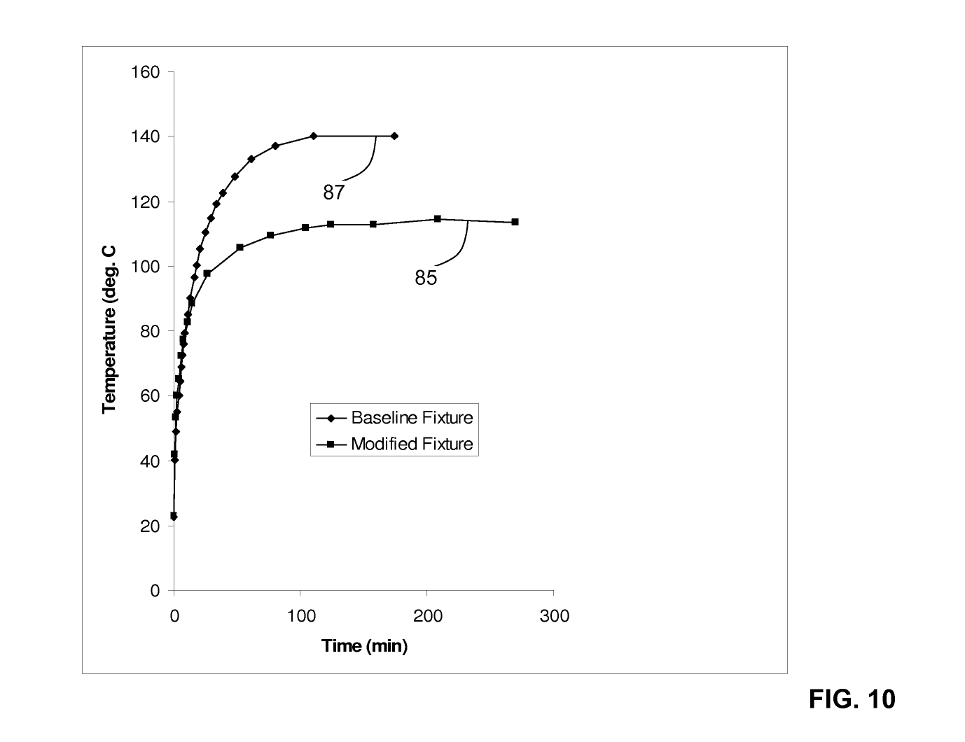

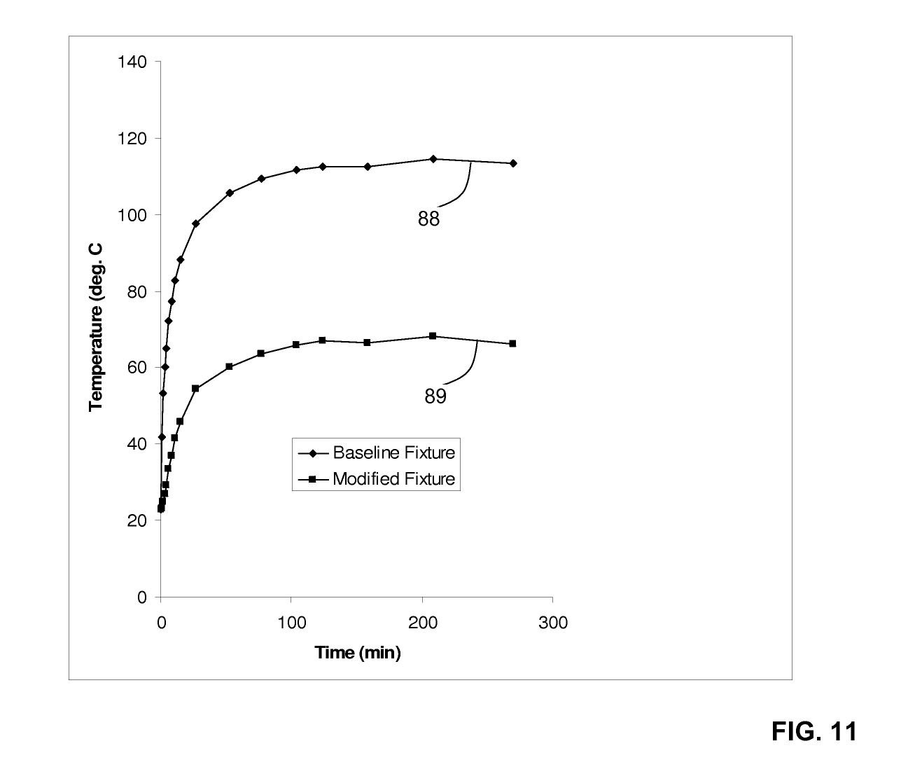

Experiments were performed on a luminaire 12a consistent with FIG. 3 as well as a flush-mounted luminaire. In particular, as generally illustrated in FIG. 9A, a first and a second thermocouple T1, T2 were placed on the light engine 30 (which was replace by a heater) and the proximal-most end 57 of a luminaire 12a consistent with FIG. 3. Similarly, a first and a second thermocouple T1, T2 were placed on the light engine 80 (which was replace by a heater) and the proximal-most end 82 of a flush-mounted luminaire 84 as generally illustrated in FIG. 9B. The light engines 30, 80 in both the luminaires 12a, 84 of FIGS. 9A and 9B generated 23 watts of thermal energy. While note shown, the luminaires 12a, 84 were also surrounded by insulation 24 to simulate a typical installation in a ceiling 14a. The temperature of the thermocouples T1 and T2 for each luminaire 12a, 84 was then recorded as a function of time as generally illustrated in FIGS. 10 and 11.

In particular, FIG. 10 generally illustrates the temperature 85, 87 of the first thermocouple T1 in each luminaire 12, 84, respectively. As may be seen, the flush-mounted luminaire 84 of FIG. 9B had a steady state temperature 87 of approximately 140 degrees C. after approximately 3-5 hours (steady state was assumed at the point when the temperature of the thermocouple T1 stopped rising). In contrast, the luminaire 12a of FIG. 9A had a steady state temperature 85 of approximately 115 degrees C. (a reduction of approximately 25 degrees C.).

Turning now to FIG. 11, the temperature 88, 89 of the second thermocouple T2 in each luminaire 12a, 84, respectively, is generally illustrated. As may be seen, the difference in the temperature 88, 89 at T2 between the luminaires 12a, 84 is even larger at the bottom 57, 82 of the luminaires 12a, 84 than it is at the light engine 30, 80. While this result may at first seem counterintuitive, the reason is that much more thermal energy is removed from the partially-recessed luminaire 12a at the bottom (due to convection) than is removed from the flush-mounted luminaire 84. The additional flow of thermal energy of the partially-recessed luminaire 12a imposes an additional temperature difference top-to-bottom in the partially-recessed luminaire 12a. As a result, the partially-recessed luminaire 12a runs approximately 40 degrees cooler at the bottom 57 compared to the bottom 82 of the flush-mounted luminaire 84.

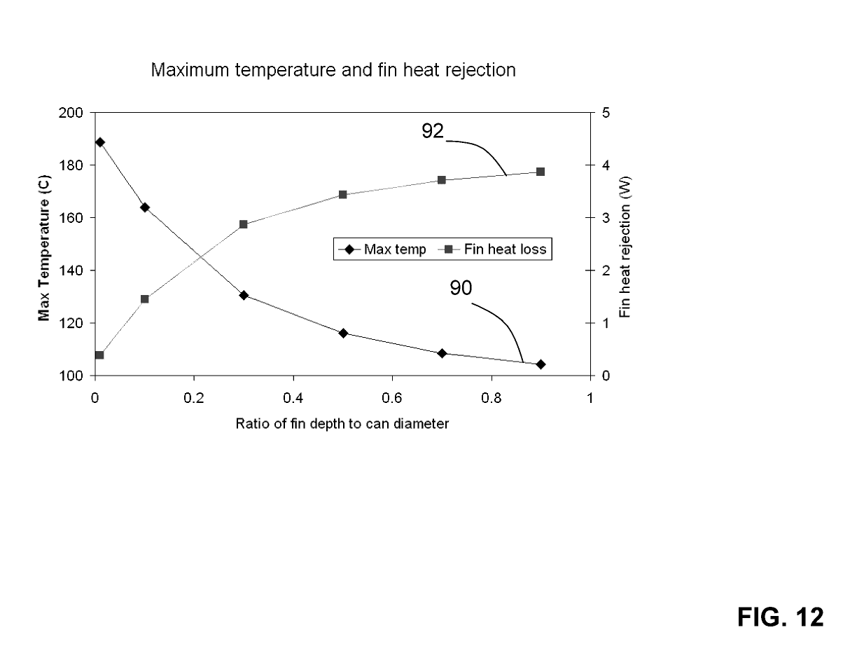

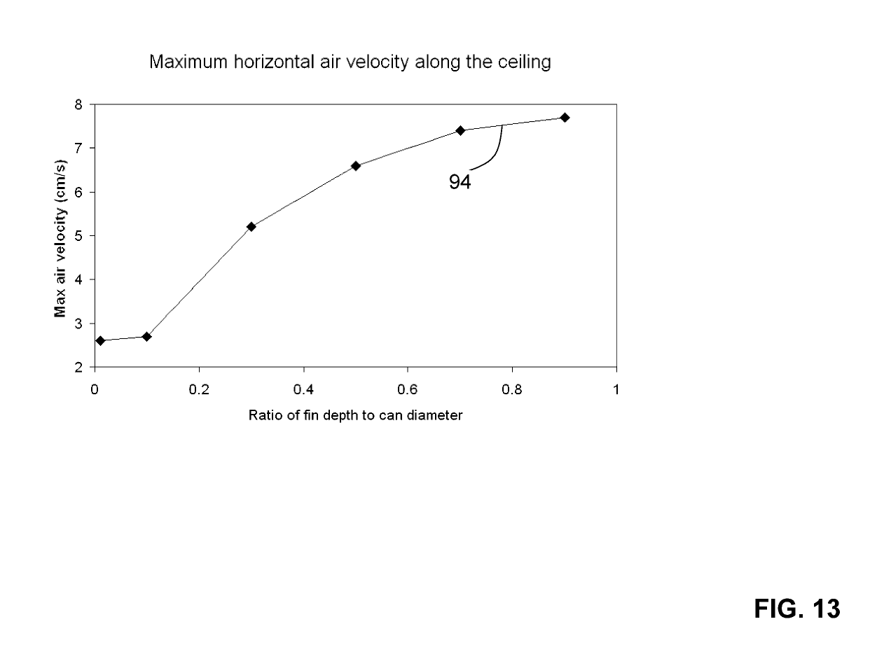

Turning now to FIGS. 12 and 13, simulations were performed on a variety of luminaires having a flared heat flange (for example, a heat flange as generally illustrated in FIG. 5) with different depths D. In particular, FIG. 12 generally illustrates the maximum temperature 90 of the light engine as a function of the normalized depth D of the heat flange. In addition, the maximum temperature 92 of the proximal-most end of the heat flange (i.e., the amount of thermal energy rejected from the heat flange to the air) was also recorded as a function of the normalized depth D of the heat flange. FIG. 13 generally illustrates maximum horizontal air velocity 94 along the ceiling as a function of the normalized depth D of the heat flange. As can be seen, the maximum horizontal air velocity 94 (FIG. 13) increases significantly after the normalized depth D of the heat flange exceeds a ratio of approximately 0.2 (i.e., 0.4R). The increased thermal energy rejection 92 and corresponding lower temperature 90 of FIG. 12 is due to the combined effects of the higher air velocity 94 of FIG. 13 and the larger exposed surface area of the heat flange.

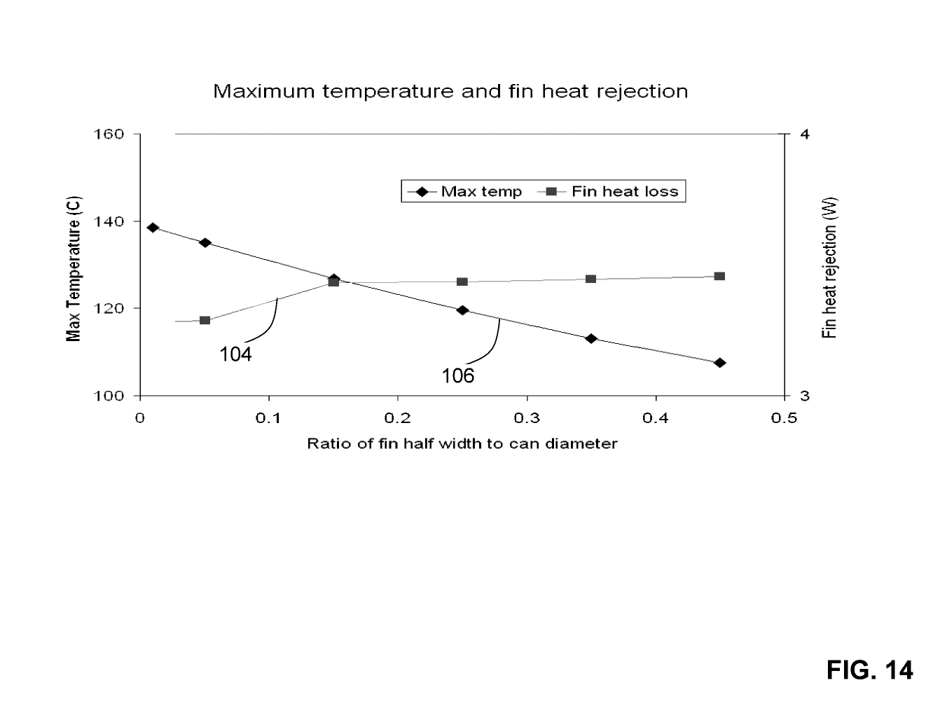

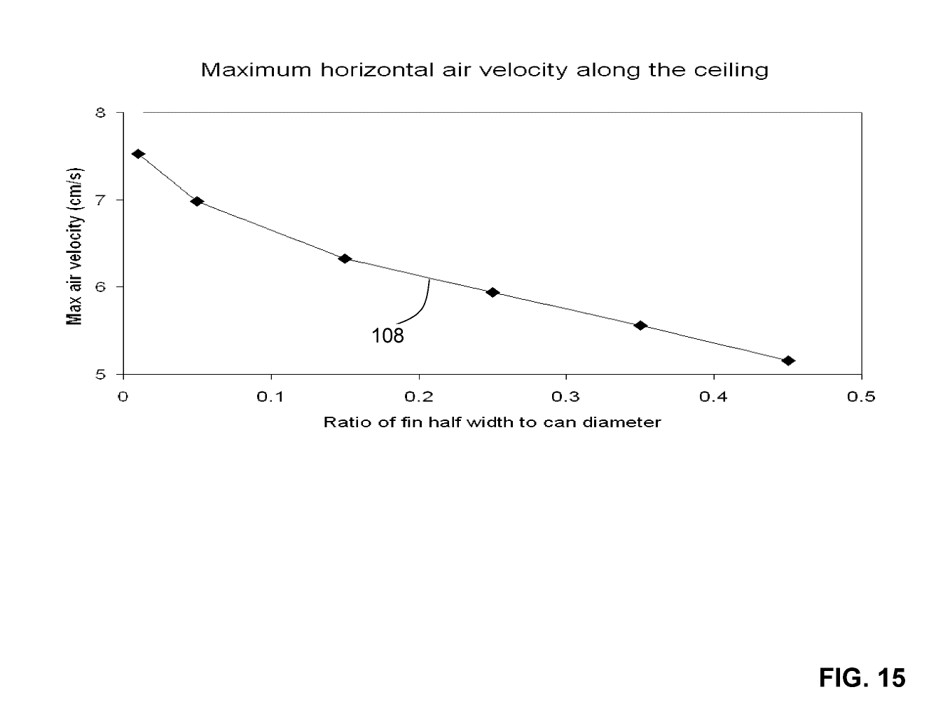

As illustrated in FIGS. 14 and 15, simulations were also performed on a variety of luminaires having a flared heat flange (for example, a heat flange as generally illustrated in FIG. 5) with different flange half-widths r. In particular, FIG. 14 generally illustrates the maximum temperature 104 of the light engine as a function of the ratio of the flange half-width r to diameter of luminaire (normalized by the normalized by the luminaire diameter). Note, that luminaire diameter is equal to 2R. In addition, the maximum temperature 106 of the proximal-most end of the heat flange (i.e., the amount of thermal energy rejected from the heat flange to the air) was also recorded as a function of the normalized luminaire diameter. FIG. 15 generally illustrates maximum horizontal air velocity 108 along the ceiling as a function of the normalized luminaire diameter.

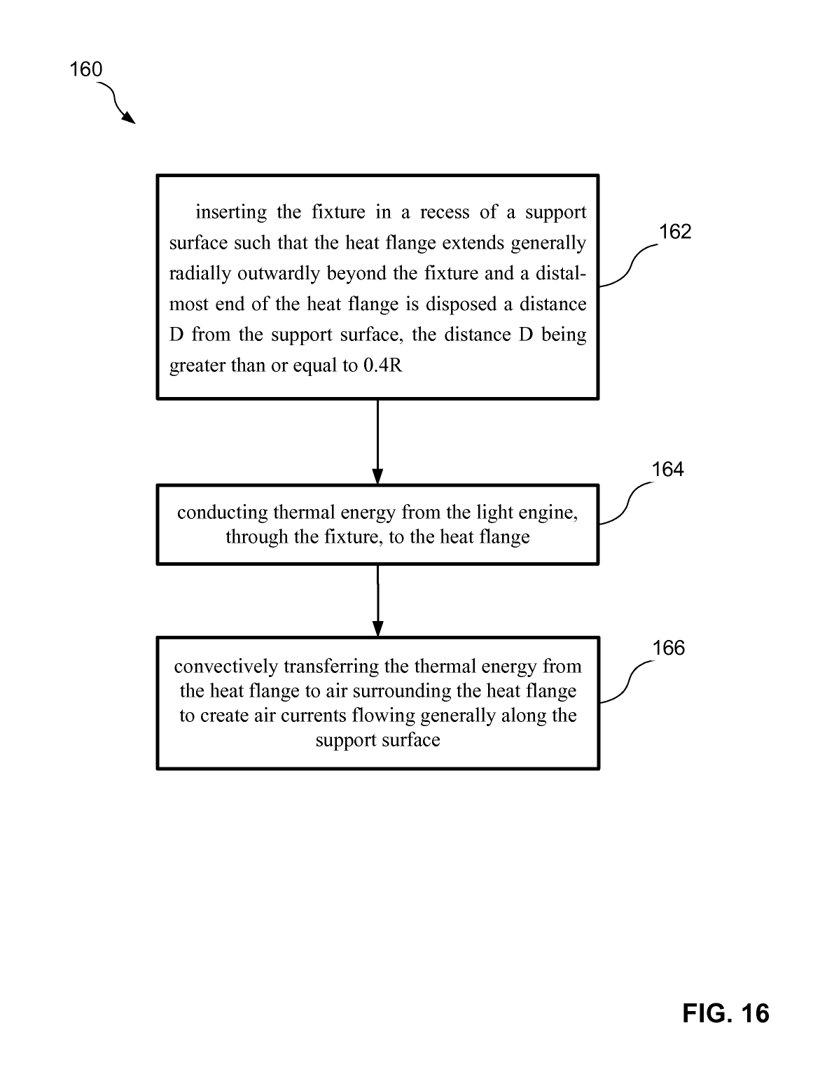

FIG. 16 is a block flow diagram of one method 160 of reducing the junction temperature of a luminaire consistent with the present disclosure. The luminaire includes a fixture defining a cavity, a light engine, and a heat flange. The fixture is inserted 162 into a recess of a support surface such that the heat flange extends generally radially outwardly beyond the fixture and a distal-most end of the heat flange is disposed a distance D from the support surface, the distance D being greater than or equal to 0.4R. Thermal energy is conducted 164 from the light engine, through the fixture, to the heat flange. The thermal energy is convectively transferred 166 from the heat flange to the air surrounding the heat flange to create air currents flowing generally along the support surface.

While the block flow diagram for FIG. 16 may be shown and described as including a particular sequence of steps. It is to be understood, however, that the sequence of steps merely provides an example of how the general functionality described herein can be implemented. The steps do not have to be executed in the order presented unless otherwise indicated.

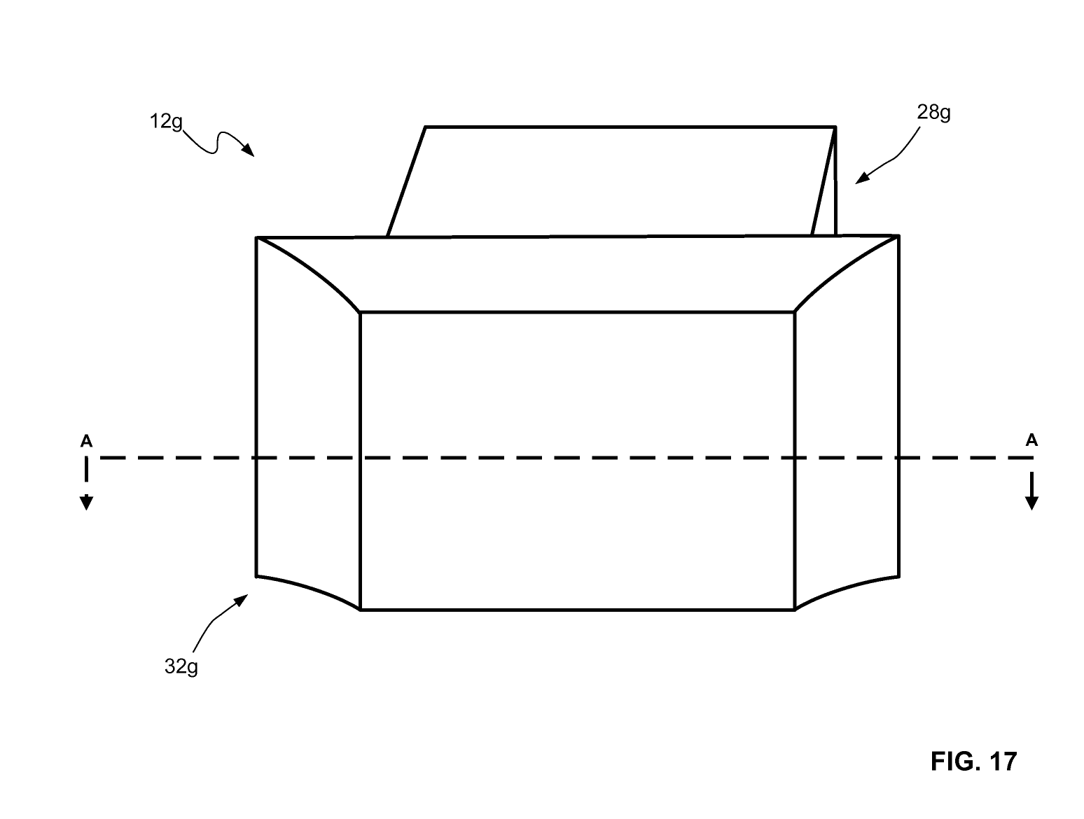

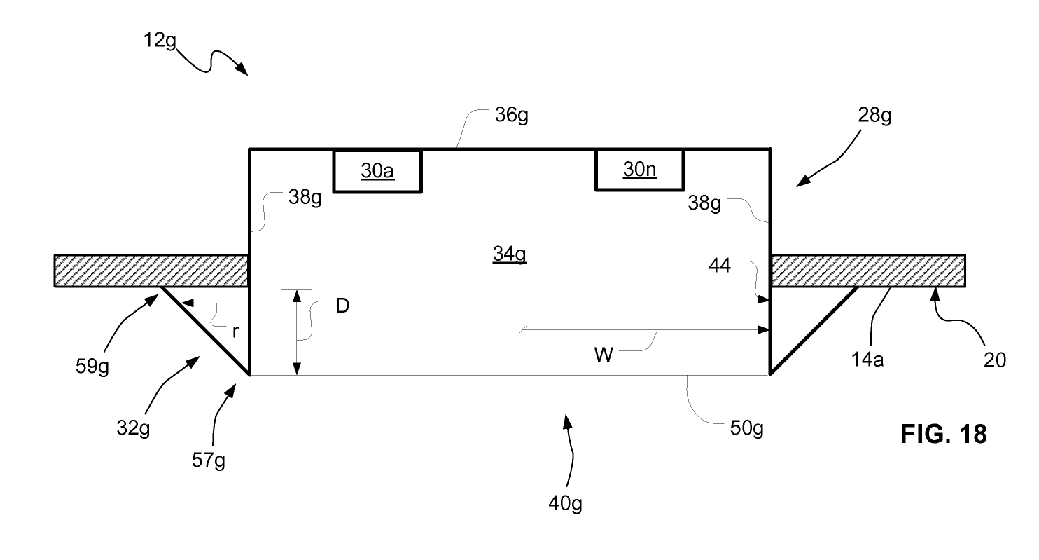

Turning now to FIGS. 17 and 18, a generally rectangular luminaire 12g is illustrated in which FIG. 18 is a cross-sectional view taken along lines A-A of FIG. 17. In particular, the generally rectangular luminaire 12g may include any of the features described herein, except that the generally rectangular luminaire 12g includes a heat flange 32g disposed around a perimeter of a fixture 28g having a generally rectangular cross-section. As used herein, the term “generally rectangular” is intended to mean that the angle between the sides may vary slightly from 90 degrees, for example, +/−10 degrees. The rectangular fixture 28g defines at least one cavity 34g configured to have an array of light engines 30a-30n. The rectangular fixture 28g has a height, a width, and a length and includes a base 36g, four sidewalls 38g, and an open end 40g. The rectangular luminaire 12g may optionally include a lens or diffuser 50g as described herein. As used herein, width and the length of the fixture 28g refer to cross-sectional distances of the fixture 28g in a common plane which is generally parallel to the surface 20 of the ceiling 14a, wherein the width is equal to or smaller than the length. In addition, the term “fixture half-width W” is intended to refer to one half of distance of the width.

As discussed above, the rectangular luminaire 12g features a heat flange 32g disposed around a perimeter of a generally rectangular fixture 28g. While the heat flange 32g extends along the perimeter of the generally rectangular fixture 28g, the heat flange 32g may have any configuration consistent with the present disclosure. For example, the heat flange 32g may include a hollow, generally pyramidal frustum shape having a generally rectangular cross-section which generally linearly tapers radially outwardly from the distal-most end 57g towards the rectangular fixture 28g, a curved or flared hollow, generally pyramidal frustum shape having a generally rectangular cross-section. As used herein, the term “generally pyramidal frustum” is intended to mean that the top and base of the pyramid may be, but do not necessarily have to be, parallel to each other. The heat flange 32g may optionally include one or more fins as described herein. Further, as noted herein, the heat flange 32g may be a separate component which may be secured to the rectangular fixture 28g (and may optionally include one or more flanges and/or thermal interface material as described herein), or may be a monolithic component with the rectangular fixture 28g. Additionally, the heat flange 32g and the rectangular fixture 28g may include any materials described herein.

The heat flange 32g has a depth D equal to or greater than 0.4 times the fixture half-width W. For example, the depth D may be equal to or greater than 0.6 times the fixture half-width W; equal to or greater than 0.8 times the fixture half-width W; and/or equal to or greater than 1.2 times the fixture half-width W. Alternatively, the depth D of the heat flange 32 may be selected to be greater than or equal to 0.4W and less than or equal to 2W; greater than or equal to 0.4W and less than or equal to 1.4W; greater than or equal to 0.8W and less than or equal to 1.6W; greater than or equal to 0.8W and less than or equal to 1.4W, and/or any value in between. It should be understood that all rectangular luminaires consistent with FIGS. 16-21 and the present disclosure feature heat flanges having the above described relationships between the distance D and the fixture half-width W.

The heat flange 32g has a maximum flange half-width r equal to or greater than 0.4 times the fixture half-width W. As used herein, the term “maximum flange half-width r” is intended to refer to the maximum radial distance of the heat flange 32g. For example, the maximum flange half-width r may correspond to the radial distance of the heat flange 32g at the proximal-most end 59g of the heat flange 32g configured to be adjacent to the ceiling 14a as generally illustrated. The heat flange 32g may also have a maximum flange half-width r equal to or greater than the fixture half-width W. It should be understood that all rectangular luminaires consistent with FIGS. 16-21 and the present disclosure feature heat flanges having the above described relationships between the maximum flange half-width r and the fixture half-width W.

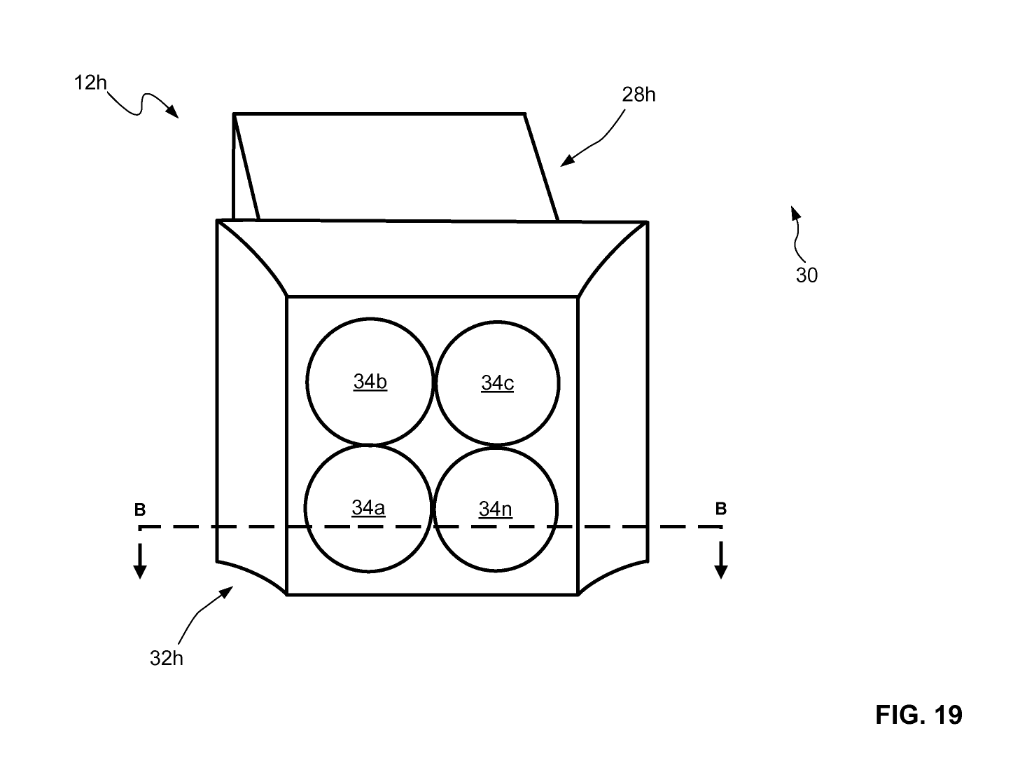

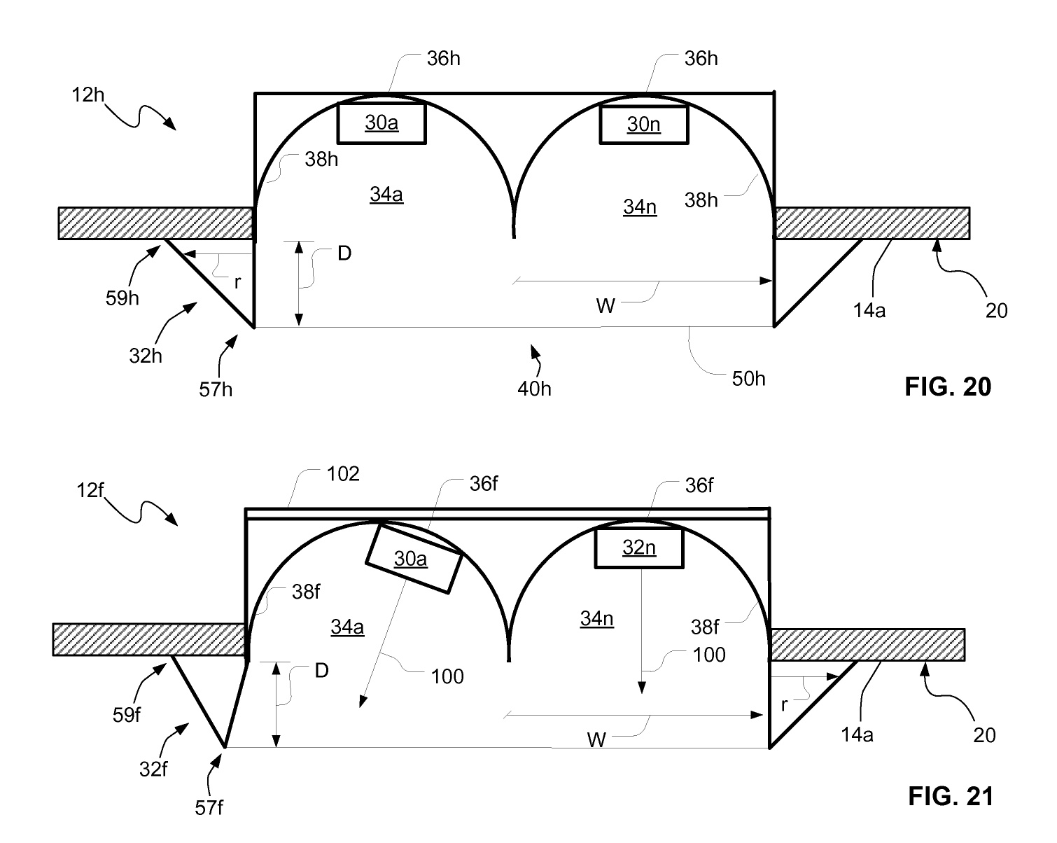

As shown in FIG. 18, the rectangular fixture 28g defines a single cavity 34g containing a plurality of light engines 30a-n. Alternatively, the rectangular fixture 28h may define a plurality of cavities 34a-n as generally illustrated in FIGS. 19 and 20. In particular, FIG. 20 is a cross-sectional view of the rectangular luminaire 12g taken along lines B-B of FIG. 19. Each cavity 34a-n may include one or more light engines 30a-n, and may have a generally circular cross-sectional. Each cavity 34a-n may also feature a reflective surface 44 configured to reflect the light emitted from the light engine 30a-n.

Turning now to FIG. 21, the rectangular luminaire 12f may optionally be configured to allow a user to adjust the position of one or more of the light engines 30a-n. Such an arrangement allows a user to adjust the illumination pattern (generally illustrated by arrow 100) generated by the rectangular luminaire 12f. For example, one or more of the cavities 34a-n may be coupled to the fixture 28f using one or more sliders 102 or the like. The rectangular luminaire 12f may therefore be configured to allow a user to adjust the orientation of a cavity 34a-n and the associated light engine 30a-n with respect to the fixture 28f.

While the exact dimension of a rectangular luminaire consistent with the present disclosure may depend upon the intended application, the rectangular luminaire 12h may have a generally square fixture 28h having a generally square heat flange 32h, for example, as illustrated in FIG. 19. For example, the fixture 28h may be 2 feet by 2 feet. Alternatively, the rectangular luminaire 12g may have a length which is greater than the length, for example, as generally illustrated in FIG. 17. For example, the fixture 28g may be 2 feet by 4 feet. It should be understood, however, that the rectangular fixture 28 is not limited to these dimensions unless specifically claimed as such.

Thus, a rectangular luminaire consistent with the present disclosure may reduce the junction temperature. The rectangular luminaire may be particularly useful in applications where vertical convection above the ceiling and/or lateral convection inside the room are suppressed. The rectangular luminaire may also be particularly useful in applications with stagnant or near stagnant air floor within a room. The rectangular luminaire may therefore run at a lower temperature with the same power (i.e., luminance) compared to a flush-mounted luminaire (thus increasing the life-expectancy of the light engine) or at a higher power with the same temperature compared to a flush-mounted luminaire while also maintaining an acceptable service life. A rectangular luminaire may include a generally rectangular fixture, at least one light engine coupled to the fixture, and a heat flange coupled to the fixture. The heat flange is configured to extend below the support surface a distance D, wherein D is greater than or equal to 0.4 times the fixture half-width W.

The present disclosure recognizes that the insulation above a luminaire in a common installation reduces the transfer of thermal energy from the luminaire and may create a bottleneck. The partially-recessed luminaire of the present disclosure reduces and/or eliminates this bottleneck by increasing the surface area of the ceiling which is used to transfer the thermal energy from the luminaire. In particular, the heat flange reduces the junction temperature of the light engine by increasing the amount of convection in the surrounding air, thereby increasing the volumetric air flow across the fixture as well as the air velocity. In particular, thermal energy is conductively transferred from the light engine, through the fixture, to the heat flange where the thermal energy is convectively transferred from the heat flange to surrounding air to create air currents flowing along the support surface. The shape of the heat flange directs the heated air outwardly away from the luminaire and generally along the surface of the support surface. This heated air is then exposed to a greater area of the support surface (i.e., the heat-flow area). Because the cross-sectional area of heat flow through the support surface is so much larger due to the increased air currents generated by the heat flange, the temperature differential required to transfer the thermal energy into the support surface is much smaller. The increased volumetric air flow and velocity transfers a greater amount of thermal energy from the fixture into the surrounding air, thereby reducing the junction temperature of the light engine.

According to one aspect, the present disclosure may feature a rectangular luminaire including a generally rectangular fixture, a plurality of light engines, and a heat flange. The generally rectangular fixture is configured to be generally received in a recess of a support surface. The light engines are configured to be disposed within the fixture and each includes at least one light source. The heat flange is disposed about a distal end region of the generally rectangular fixture and includes a generally conical cross-section extending generally radially outwardly beyond the generally rectangular fixture and extending away from the distal end region of the generally rectangular fixture. A distal-most end of the heat flange is configured to be disposed a distance D from the support surface when the generally rectangular fixture is received in the recess. The distance D being greater than or equal to 0.4W, wherein W is the fixture half-width.

According to another aspect, the present disclosure may feature a rectangular luminaire including generally rectangular fixture, a plurality of light engines, and a heat flange. The generally rectangular fixture is configured to be generally received in a recess of a support surface. The light engines are configured to be disposed within the generally rectangular fixture and each includes at least one light source. The heat flange is disposed about a distal end region of the generally rectangular fixture and includes a generally conical cross-section extending generally radially outwardly beyond the generally rectangular fixture and extending away from the distal end region of the generally rectangular fixture. A distal-most end of the heat flange is configured to be disposed a distance D from the support surface when the generally rectangular fixture is received in the recess, the distance D being greater than or equal to 0.4W, wherein W is the fixture half-width. The heat flange also has a maximum flange half-width r equal to or greater than 0.4 W.

The terms “first,” “second,” “third,” and the like herein do not denote any order, quantity, or importance, but rather are used to distinguish one element from another, and the terms “a” and “an” herein do not denote a limitation of quantity, but rather denote the presence of at least one of the referenced item.

While the principles of the present disclosure have been described herein, it is to be understood by those skilled in the art that this description is made only by way of example and not as a limitation as to the scope of the invention. The features and aspects described with reference to particular embodiments disclosed herein are susceptible to combination and/or application with various other embodiments described herein. Such combinations and/or applications of such described features and aspects to such other embodiments are contemplated herein. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A rectangular luminaire comprising:
a generally rectangular fixture configured to be generally received in a recess of a support surface;
a plurality of light engines configured to be disposed within said generally rectangular fixture, said light engines each comprising at least one light source; and
a heat flange disposed about a distal end region of said generally rectangular fixture, said heat flange having a hollow, generally pyramidal frustum shape with a generally rectangular cross-section extending generally radially outwardly beyond said generally rectangular fixture and extending away from said distal end region of said generally rectangular fixture, wherein a distal-most end of said heat flange is configured to be disposed a distance D from said support surface when said generally rectangular fixture is received in said recess, said distance D being greater than or equal to 0.4W, wherein W is the fixture half-width.

2. The rectangular luminaire of claim 1, wherein said generally conical cross-section of said heat flange generally linearly tapers radially outwardly from a proximal end region of the heat flange to said distal-most end of said heat flange.

3. The rectangular luminaire of claim 1, wherein said heat flange has a curved, generally conical cross-section.

4. The rectangular luminaire of claim 3, wherein said curved, generally conical cross-section is concaved.

5. The luminaire of claim 3, wherein said curved, generally conical cross-section is convex.

6. The rectangular luminaire of claim 1, wherein said heat flange further comprises at least one fin extending generally outwardly from said heat flange.

7. The rectangular luminaire of claim 1, wherein said fixture and said heat flange is a monolithic component.

8. The rectangular luminaire of claim 1, wherein said heat flange is removably secured to said fixture.

9. The rectangular luminaire of claim 1, wherein said generally rectangular fixture comprises a plurality of cavities, said cavities each having at least one light engine.

10. The rectangular luminaire of claim 9, wherein a light engine associated with at least one of said cavities moveable with respect to said generally rectangular fixture.

11. The rectangular luminaire of claim 9, wherein at least one of said cavities has a generally circular cross-section.

12. The rectangular luminaire of claim 1, wherein said distance D is greater than or equal to 0.6W.

13. The rectangular luminaire of claim 1, wherein said distance D is greater than or equal to 0.8W.

14. The rectangular luminaire of claim 1, wherein said distance D is less than or equal to 2W.

15. The rectangular luminaire of claim 1, wherein said light engine comprises at least one light emitting diode.

16. The rectangular luminaire of claim 1, wherein said light engine is coupled to a base region of said cavity.

17. A rectangular luminaire comprising:
a generally rectangular fixture configured to be generally received in a recess of a support surface;
a plurality of light engines configured to be disposed within said generally rectangular fixture, said light engines each comprising at least one light source; and
a heat flange disposed about a distal end region of said generally rectangular fixture, said heat flange having a hollow, generally pyramidal frustum shape with a generally rectangular cross-section extending generally radially outwardly beyond said generally rectangular fixture and extending away from said distal end region of said generally rectangular fixture;
wherein a distal-most end of said heat flange is configured to be disposed a distance D from said support surface when said generally rectangular fixture is received in said recess, said distance D being greater than or equal to 0.4W, wherein W is the fixture half-width; and
wherein said heat flange has a maximum flange half-width r equal to or greater than 0.4 W.

18. The rectangular luminaire of claim 17, wherein said generally rectangular fixture comprises a plurality of cavities, said cavities each having at least one light engine.

19. The rectangular luminaire of claim 17, wherein said light engine comprises at least one light emitting diode.

20. The rectangular luminaire of claim 19, wherein at least one of said cavities has a generally circular cross-section.
